(19) United States
(12) Patent Application Publication
(10) Pub. No.: US 2013/0300863 A1
(43) Pub. Date: Nov. 14, 2013

(54) PET SITTER

(71) Applicants: Kevin Tait, Austin, TX (US); Yair Frenkel, AUSTIN, TX (US)

(72) Inventors: Kevin Tait, Austin, TX (US); Yair Frenkel, AUSTIN, TX (US)

(21) Appl. No.: 13/466,958

(22) Filed: May 8, 2012

(51) Int. Cl. H04N 7/18

(52) U.S. Cl. 348/143; 348/E07.085

(57) ABSTRACT

One example embodiment includes a system for allowing a user to interact remotely with a pet. The system includes a camera, where the camera is configured to capture an image of a pet. The system also includes a microphone, where the microphone is configured to capture a sound made by the pet. The system further includes a speaker, where the speaker is configured to play one or more sounds to the pet.

### CROSS-REFERENCE TO RELATED APPLICATIONS

Not applicable.

### BACKGROUND OF THE INVENTION

Hundreds of millions of pets are owned in the US and throughout the world. Pets are a source of companionship for many who treat their pets as members of their families. In addition, interaction with pets has been shown, in numerous studies, to increase the health and happiness of those who interact with them.

Most of these interactions occur in person. I.e., the person and the pet are in close proximity to one another. However, this in not always feasible. For example, the person may need to work or may be limited by mobility or otherwise be prevented from being in close proximity to the pet. In these situation, interaction generally does not occur or occurs only when facilitated by another person who is in close proximity to the pet.

In addition, many owners feel great anxiety for their pets. In particular, they may worry when separated from the pet for an extended period of time. These owners are often likewise prevented from checking on their pets without a human intermediary who checks on the pet and then reports the condition of the pet to the owner. For example, the owner may request a friend or neighbor to check on the pet and then call or otherwise contact the owner.

However, some of these pets may suffer anxiety from this interaction. For example, some pets get nervous or scared when around people who they are not familiar with. Likewise, some pets get nervous when owners are away, whether or not they are familiar with the person or people checking on them.

Accordingly, there is a need in the art for a device that allows a person to interact with a pet remotely.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for allowing a user to interact remotely with a pet. The system includes a camera, where the camera is configured to capture an image of a pet. The system also includes a microphone, where the microphone is configured to capture a sound made by the pet. The system further includes a speaker, where the speaker is configured to play one or more sounds to the pet.

Another example embodiment includes a system for allowing a user to interact remotely with a pet. The system includes a camera, where the camera is configured to capture an image of a pet. The system also includes a microphone, where the microphone is configured to capture a sound made by the pet. The system further includes a speaker, where the speaker is configured to play one or more sounds to the pet. The system additionally includes a network connection, where the network connection is configured to allow a user to control the system over a network. The system also includes a treat dispenser and a toy.

Another example embodiment includes a system for allowing a user to interact remotely with a pet. The system includes a video display, where the video display is configured to display an image of the pet. The system also includes a speaker, where the speaker is configured to reproduce a sound made by the pet. The system further includes at least one control, where the at least one control is configured to allow a user to control a device which is located near the pet.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates a system for interacting remotely with a pet;

FIG. 2 illustrates an example of an interactive system;

FIG. 3 illustrates an example of a user interface for interacting with a pet; and

FIG. 4 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

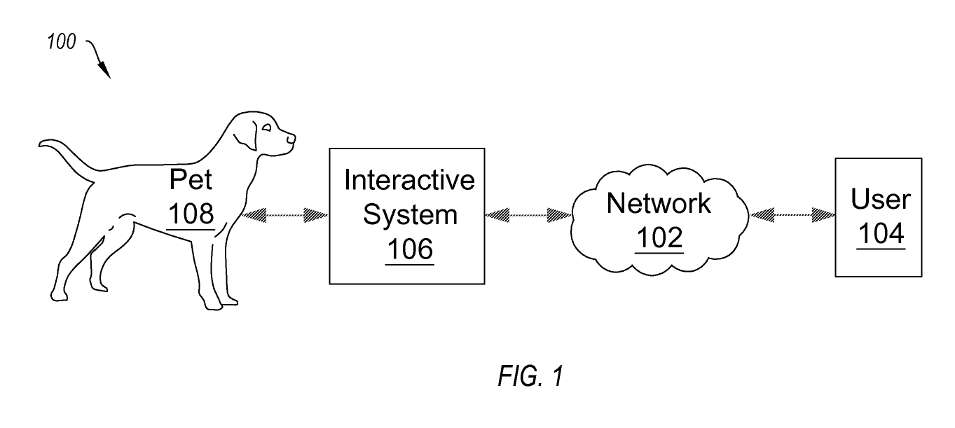

FIG. 1 illustrates a system 100 for interacting remotely with a pet. In at least one implementation, the system 100 can allow a user to interact with a pet while physically separated. For example, the system 100 can allow a user to interact with the pet while at work, on vacation, or otherwise separated from the pet. The interaction may be one way or two way. For example, the interaction can include the user speaking or otherwise communicating to the pet. Additionally or alternatively, the interaction can include the user checking on the pet, visually or auditorily.

FIG. 1 shows that the system 100 can include a network 102. In at least one implementation, the network 102 can be used to connect the various parts of the system 100 to one another. The network 102 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 102 includes one or more cellular RF networks and/or one or more wired and/or wireless networks such as, but not limited to, 802.xx networks, Bluetooth access points, wireless access points, IP-based networks, or the like. For example, the network 102 can include cloud based networking and computing. The network 102 can also include servers that enable one type of network to interface with another type of network.

FIG. 1 also shows that the system 100 can include a user 104. In at least one implementation, the user 104 can include any individual who wishes to interact remotely with a pet. For example, the user 104 can include a pet owner, a pet sitter or any other individual. The user 104 can interact with the pet over the network 102. For example, the user 104 can use a smartphone, web browser, software application or any other means of connecting over the network 102.

FIG. 1 further shows that the system 100 can include an interactive system 106. In at least one implementation, the interactive system 106 can include one or more components for allowing a user to interact with a pet. For example, the interactive system 106 can include a video camera, a speaker, a microphone, a treat dispenser, a laser toy, memory for playing back sounds or recording images, network connection for connecting to network 102 or any other interactive components.

FIG. 1 additionally shows that the system 100 can include a pet 108. In at least one implementation, the pet 108 can include any animal with whom the user 104 desires to interact. For example, the pet 108 can include a dog, a cat, a snake, a hamster, a gerbil, a bird, fish or any other pet. One of skill in the art will appreciate that the pet 108 can include any animal. The animal may be capable of interacting with the interactive system 106 or may be capable of being observed by the interactive system 106.

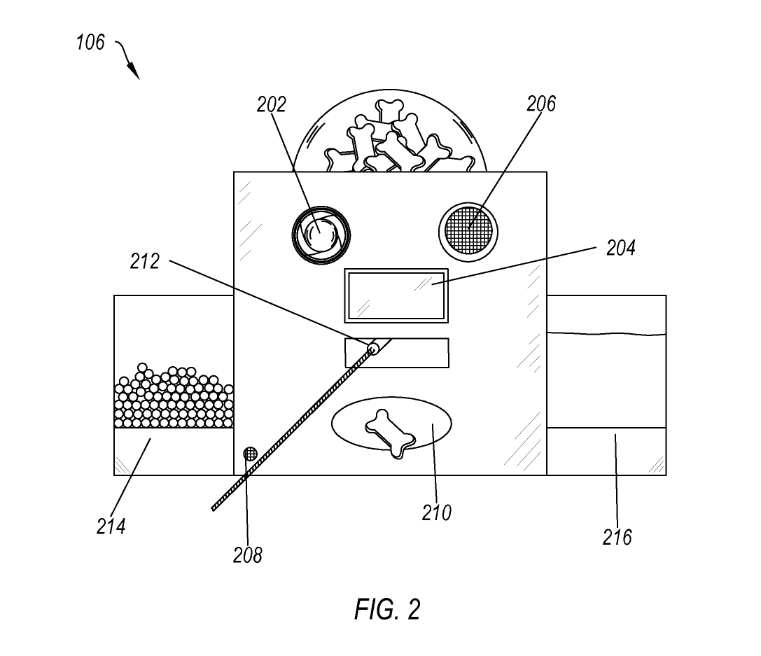

FIG. 2 illustrates an example of an interactive system 106. In at least one implementation, the interactive system 106 can allow a user to interact with a pet in one or more ways. In particular, the interactive system 106 can be controlled by a remote user, allowing the user to interact with the pet. The interactive system 106 can allow the user to view the pet and/or speak with the pet and vice versa.

FIG. 2 shows that the interactive system 106 can include a camera 202. In at least one implementation, the camera 202 can include any device for capturing and/or transmitting images or video. In particular, the camera 202 can include any device which is configured to capture an image of a pet and/or transmit the image over a network to a user.

FIG. 2 also shows that the interactive system 106 can include a display 204. In at least one implementation, the display 204 can include any device capable of displaying images. In particular, the display 204 serves as a surface for images to be shown to a pet. I.e., the display 204 includes display circuitry which broadcasts an image, or series of images, that are shown on the display 204. For example, the display 204 can be made of glass, plastic or other material that allows the display circuitry to broadcast the image on one side of the display 204, while a user views the image from the other side of the screen. Additionally or alternatively, the display 204 can be a projection surface where the display circuitry can broadcast an image that is reflected to a user, who is on the same side of the display 204 as the display circuitry. One of skill in the art will appreciate that the location of the display circuitry relative to the display 204 and to the user is not limiting unless otherwise stated in the specification or the claims. For example, the display 204 can include television sets, computer monitors, video display panels, projectors, liquid crystal displays (“LCD”s) or light emitting diode (“LED”) displays. One of skill in the art will appreciate that the display 204 can include any other device that converts an electronic signal into a image unless otherwise stated in the specification or the claims.

FIG. 2 further shows that he interactive system 106 can include a speaker 206. In at least one implementation, the speaker 206 can include an electroacoustic transducer that converts an electrical signal into sound that can be perceived by a user. Specifically, the speaker 206 can move in accordance with the variations of an electrical signal and causes sound waves to propagate through a medium. In particular, the speaker 206 can be used to produce sound from a data signal sent to the interactive system 106. The speaker 206 can be part of the interactive system 106 or can be an external device such as external speakers.

FIG. 2 additionally shows that the interactive system 106 can include a microphone 208. In at least one implementation, the microphone 208 can include an acoustic-to-electric transducer or sensor that converts sound into an electrical signal. I.e., the microphone 208 can include a device which converts sound into an electrical signal for recordation and/or transmission over a network. The microphone 208 can use electromagnetic induction (dynamic microphone), capacitance change (condenser microphone), piezoelectric generation, or light modulation to produce an electrical voltage signal from mechanical vibration.

FIG. 2 also shows that the interactive system 106 can include a treat dispenser 210. In at least one implementation, the treat dispenser 210 can dispense a desired treat for the pet when specified by a user. For example, the user can specify a time or times at which the treat will be dispensed. Additionally or alternatively, if the user is logged on and interacting with the pet, the user can have the option of dispensing a treat via the treat dispenser 210.

FIG. 2 further shows that the interactive system 106 can include a toy 212. In at least one implementation, the toy 212 can allow a user to play with the pet. For example, the toy 212 can include a laser pointer or other device that creates a moving object for the pet to chase. Additionally or alternatively, the toy 212 can include a toy mouse, a chew toy, a tug toy or any other toy that the user desires to use to play with the pet.

FIG. 2 additionally shows that the interactive system 106 can include a food dispenser 214. In at least one implementation, the food dispenser 214 can provide a set amount of food to the pet. For example, the food dispenser 214 can provide a pre-determined amount of food at a set time each day to the pet. Additionally or alternatively, the food dispenser 214 can ensure that the pet has a full food dish. I.e., as the food level lowers, the food dispenser 214 can release additional food.

FIG. 2 also shows that the interactive system 106 can include a water dispenser 216. In at least one implementation, the water dispenser 216 can ensure that the pet has sufficient clean water for drinking. In particular, the water dispenser 216 can ensure that the pet has access to water as needed. For example, the water dispenser 216 can include a mechanism that adds water when the level falls below a predetermined level. Additionally or alternatively, the water dispenser 216 can include a filter or a valve that ensures that the water is clean.

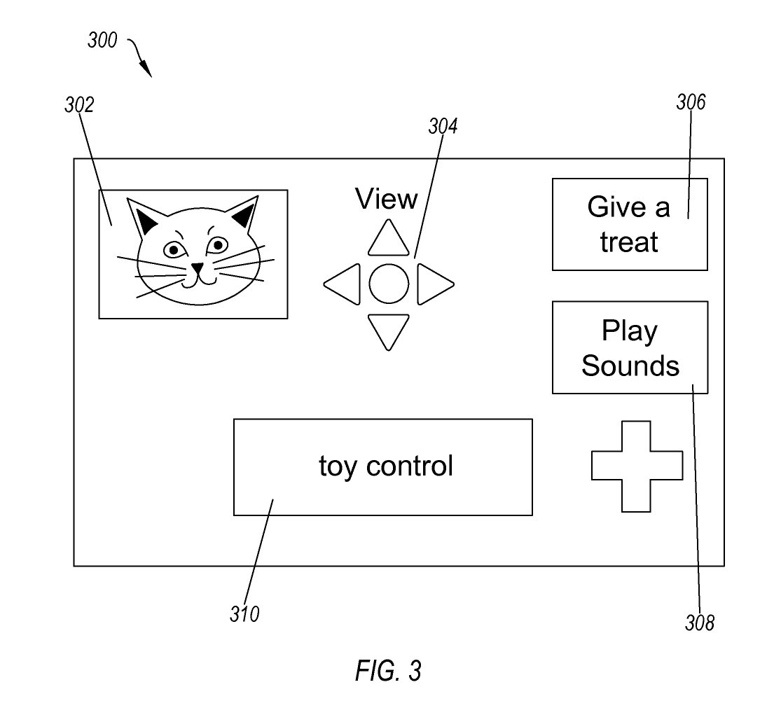

FIG. 3 illustrates an example of a user interface 300 for interacting with a pet. In at least one implementation, the user interface 300 can allow the user to view, hear, play with or otherwise interact with the pet. For example, the user interface 300 can include a graphical user interface, controls, speakers, displays or any other necessary hardware and/or software to adequately display the media file to the user, as described below.

In at least one implementation, a graphical user interface (“GUI” sometimes pronounced gooey) is a type of user interface 300 that allows users to interact with electronic devices with images rather than text commands. GUIs can be used in computers, hand-held devices such as MP3 players, portable media file players or gaming devices, cell phones, tablets, household appliances, office equipment and any other desired device. A GUI represents the information and actions available to a user through graphical icons and visual indicators such as secondary notation, as opposed to text-based interfaces, typed command labels or text navigation. The actions are usually performed through direct manipulation of the graphical elements.

FIG. 3 shows that the user interface 300 can include a video display 302. In at least one implementation, the video display 302 can allow a user to view the pet. I.e., the video display 302 can include a portion of the user interface that shows images or video of the pet in real time or near real time. In particular, the images are transmitted from a video camera to the video display 302.

FIG. 3 also shows that the user interface 300 can include video controls 304. In at least one implementation, the video controls 304 can allow the user to change the area being recorded by the video camera. I.e., the video controls 304 can allow the user to move the direction in which the video camera is pointing, change the zoom of the camera, toggle between still images and video, change recording mode, change focus or modify any other desired parameter.

FIG. 3 further shows that the user interface 300 can include a treat command 306. In at least one implementation, the treat command 306 can allow the user to dispense a treat to the pet. In particular, the user can select the treat command 306 to dispense a treat immediately or program a time at which the treat will be dispensed. For example, the treat command 306 can allow the user to select to immediately dispense a treat. Additionally or alternatively, the treat command 306 can allow the user to set-up a schedule under which treats will be dispensed.

FIG. 3 additionally shows that the user interface 300 can include a sound command 308. In at least one implementation, the sound command 308 can allow the user to play a desired sound for the pet. For example, the sound command 308 can include pre-recorded sounds for pets, such as other animals, white noise, comforting words, or some other desired sound. The sound command 308 may allow the user to select from among the pre-recorded sounds or can play a pre-determined sequence and/or sound.

FIG. 3 also shows that the user interface 300 can include a toy control 310. In at least one implementation, the toy control 310 can allow the user to control a toy for the pet. The toy control 310 can allow the user to turn on/off the toy and/or control the movement of the toy. For example, the toy control can allow the user to control the direction that a laser pointer is pointing, allowing the pet to “chase” the laser.

One of skill in the art will appreciate that the user interface 300 can include additional controls and/or hardware as desired. For example, the user interface 300 can include a microphone and/or speakers to allow the user to speak to or hear his/her pet. Additionally or alternatively, the user interface can include customized controls for the pet which can allow the user to “program” a sequence of actions to be taken.

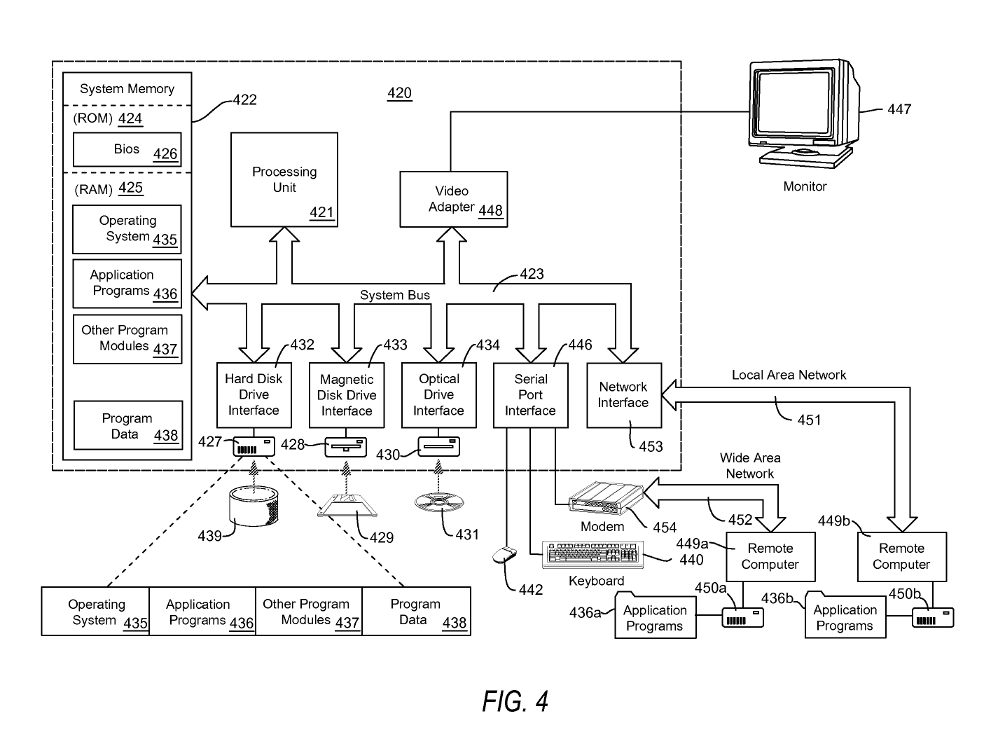

FIG. 4, and the following discussion, are intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One of skill in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 4, an example system for implementing the invention includes a general purpose computing device in the form of a conventional computer 420, including a processing unit 421, a system memory 422, and a system bus 423 that couples various system components including the system memory 422 to the processing unit 421. It should be noted however, that as mobile phones become more sophisticated, mobile phones are beginning to incorporate many of the components illustrated for conventional computer 420. Accordingly, with relatively minor adjustments, mostly with respect to input/output devices, the description of conventional computer 420 applies equally to mobile phones. The system bus 423 may be any of several types of bus structures including a memory bus or memory controller, a peripheral bus, and a local bus using any of a variety of bus architectures. The system memory includes read only memory (ROM) 424 and random access memory (RAM) 425. A basic input/output system (BIOS) 426, containing the basic routines that help transfer information between elements within the computer 420, such as during start-up, may be stored in ROM 424.

The computer 420 may also include a magnetic hard disk drive 427 for reading from and writing to a magnetic hard disk 439, a magnetic disk drive 428 for reading from or writing to a removable magnetic disk 429, and an optical disc drive 430 for reading from or writing to removable optical disc 431 such as a CD-ROM or other optical media. The magnetic hard disk drive 427, magnetic disk drive 428, and optical disc drive 430 are connected to the system bus 423 by a hard disk drive interface 432, a magnetic disk drive-interface 433, and an optical drive interface 434, respectively. The drives and their associated computer-readable media provide nonvolatile storage of computer-executable instructions, data structures, program modules and other data for the computer 420. Although the exemplary environment described herein employs a magnetic hard disk 439, a removable magnetic disk 429 and a removable optical disc 431, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 439, magnetic disk 429, optical disc 431, ROM 424 or RAM 425, including an operating system 435, one or more application programs 436, other program modules 437, and program data 438. A user may enter commands and information into the computer 420 through keyboard 440, pointing device 442, or other input devices (not shown), such as a microphone, joy stick, game pad, satellite dish, scanner, motion detectors or the like. These and other input devices are often connected to the processing unit 421 through a serial port interface 446 coupled to system bus 423. Alternatively, the input devices may be connected by other interfaces, such as a parallel port, a game port or a universal serial bus (USB). A monitor 447 or another display device is also connected to system bus 423 via an interface, such as video adapter 448. In addition to the monitor, personal computers typically include other peripheral output devices (not shown), such as speakers and printers.

The computer 420 may operate in a networked environment using logical connections to one or more remote computers, such as remote computers 449a and 449b. Remote computers 449a and 449b may each be another personal computer, a server, a router, a network PC, a peer device or other common network node, and typically include many or all of the elements described above relative to the computer 420, although only memory storage devices 450a and 450b and their associated application programs 436a and 436b have been illustrated in FIG. 4. The logical connections depicted in FIG. 4 include a local area network (LAN) 451 and a wide area network (WAN) 452 that are presented here by way of example and not limitation. Such networking environments are commonplace in office-wide or enterprise-wide computer networks, intranets and the Internet.

When used in a LAN networking environment, the computer 420 can be connected to the local network 451 through a network interface or adapter 453. When used in a WAN networking environment, the computer 420 may include a modem 454, a wireless link, or other means for establishing communications over the wide area network 452, such as the Internet. The modem 454, which may be internal or external, is connected to the system bus 423 via the serial port interface 446. In a networked environment, program modules depicted relative to the computer 420, or portions thereof, may be stored in the remote memory storage device. It will be appreciated that the network connections shown are exemplary and other means of establishing communications over wide area network 452 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for allowing a user to interact remotely with a pet, the system comprising:
a camera, wherein the camera is configured to capture an image of a pet;
a microphone, wherein the microphone is configured to capture a sound made by the pet; and
a speaker, wherein the speaker is configured to play one or more sounds to the pet.

2. The system of claim 1 further comprising a memory, wherein the memory is configured to store at least one of:
a sound to be played over the speaker; or
an image captured by the camera.

3. The system of claim 1 further comprising a network connection.

4. The system of claim 3, wherein the network connection is configured to connect to the Internet.

5. The system of claim 3, wherein the network connection is configured to connect to a cellular data network.

6. The system of claim 1 wherein the camera is configured to record an image of the pet.

7. The system of claim 1, wherein the camera is configured to transmit an image of the pet.

8. The system of claim 1 wherein the microphone is configured to record a sound produced by the pet.

9. The system of claim 1, wherein the microphone is configured to transmit a sound produced by the pet.

10. A system for allowing a user to interact remotely with a pet, the system comprising:
a camera, wherein the camera is configured to capture an image of a pet;
a microphone, wherein the microphone is configured to capture a sound made by the pet; and
a speaker, wherein the speaker is configured to play one or more sounds to the pet;
a network connection, wherein the network connection is configured to allow a user to control the system over a network;
a treat dispenser; and
a toy.

11. The system of claim 10 further comprising a motor, wherein the motor is configured to move the toy.

12. The system of claim 10, wherein the toy includes a laser pointer.

13. The system of claim 10, wherein the treat dispenser releases a treat according to a pre-determined schedule.

14. The system of claim 10, wherein the treat dispenser includes an upper limit on the number of treats to be released.

15. The system of claim 10, wherein the treat dispenser releases a treat upon receipt of a signal from the user over the network connection.

16. A system for allowing a user to interact remotely with a pet, the system comprising:
a video display, wherein the video display is configured to display an image of the pet;
a speaker, wherein the speaker is configured to reproduce a sound made by the pet; and
at least one control, wherein the at least one control is configured to allow a user to control a device which is located near the pet.

17. The system of claim 16, wherein the at least one control includes a toy control, wherein the toy control allows a user to control a toy located near the pet.

18. The system of claim 16, wherein the at least one control includes a treat control, wherein the treat control allows the user to dispense a treat to the pet.

19. The system of claim 16, wherein the at least one control includes a sound control, wherein the sound control allows the user to play a pre-recorded sound for the pet.

20. The system of claim 16 further comprising a microphone, wherein the microphone allows the user to speak to the pet.
